(19) United States
(12) Patent Application Publication
(10) Pub. No.: US 2019/0039081 A1
(43) Pub. Date: Feb. 7, 2019

(54) Solids Conveyance across Pressure and other Gradients using a Piston with a Hollow

(71) Applicants: Larry Baxter, Orem, UT (US); Jacom Chamberlain, Provo, UT (US); David Frankman, Provo, UT (US); Nathan Davis, Bountiful, UT (US)

(72) Inventors: Larry Baxter, Orem, UT (US); Jacom Chamberlain, Provo, UT (US); David Frankman, Provo, UT (US); Nathan Davis, Bountiful, UT (US)

(21) Appl. No.: 15/668,988

(22) Filed: Aug. 4, 2017

(51) Int. Cl. B05B 7/14

(52) U.S. Cl. CPC B05B 7/1459; B65G 2201/042

(57) ABSTRACT

A device and method for transferring solid particles between zones of different ambient conditions is disclosed. A piston chamber comprising a solids inlet, a solids outlet, and a piston is provided. The solids inlet is adjacent to a source of solid particles, the source being at a first ambient condition. The solids outlet is adjacent to a solids receptacle, the solids receptacle being at a second ambient condition. The piston comprises a hollow. The piston traverses back and forth across the piston chamber such that the hollow is moved alternately adjacent to the solids inlet and the solids outlet. The solid particles pass into the hollow as the hollow is adjacent to the solids inlet, and pass out of the hollow as the hollow is adjacent to the solids outlet.

This invention was made with government support under DE-FE0028697 awarded by The Department of Energy. The government has certain rights in the invention.

### FIELD OF THE INVENTION

This invention relates generally to transport of solids. More particularly, we are interested in transporting solids between zones of differing pressures or other conditions.

### BACKGROUND

Solids handling is required in nearly all industries. One of the great difficulties in these industries is transferring solids across a pressure gradient or other gradients. One common solution is to fluidize the solids. This can be done as a liquid slurry or by aeration of solids in pneumatic transport, as in fluidized beds and lift pipes.

Liquid slurries are excellent solutions, when the solids can be transferred in a liquid. However, in many solid transport processes, this would be a step backwards, as removing liquids is part of earlier processing steps. Further, solids may react or change as they are in the liquid.

Pneumatic transport works well in many cases. For example, transporting fuels into a burner, with the fuels being carried by air for combustion. However, pneumatic transport across a pressure gradient generally requires the solids be passed through lock hoppers or similar in order to step the solids up in pressure. Large amounts of dust are often produced, necessitating complex baghouses for dust suppression. Further, hot solids can be cooled, or cold solids warmed, during pneumatic transport, which can reduce efficiencies of heat exchange processes.

A solids conveyance process to pass solids across pressure gradients with minimal pressure losses and without fluidizing is required.

U.S. Pat. No. 3,001,652, to Schroeder, et al., teaches an apparatus for feeding finely divided solids. The present disclosure differs from this prior art disclosure in that the prior art disclosure requires aeration of solids and the piston involved does not transport the solids in a hollow in the piston. This prior art disclosure is pertinent and may benefit from the devices disclosed herein and is hereby incorporated for reference in its entirety for all that it teaches.

U.S. Pat. No. 2,667,280, to Lane, et al., teaches a method for handling finely divided solid materials. The present disclosure differs from this prior art disclosure in that the prior art disclosure the piston does not transport the solids in a hollow in the piston. Further, the solids are fluidized, being drawn through a check valve into the piston chamber, and then are pushed out through a second check valve. This prior art disclosure is pertinent and may benefit from the devices disclosed herein and is hereby incorporated for reference in its entirety for all that it teaches.

### SUMMARY

A device and method for transferring solid particles between zones of different ambient conditions is disclosed. A piston chamber comprising a solids inlet, a solids outlet, and a piston is provided. The solids inlet is adjacent to a source of solid particles, the source being at a first ambient condition. The solids outlet is adjacent to a solids receptacle, the solids receptacle being at a second ambient condition. The piston comprises a hollow. The piston traverses back and forth across the piston chamber such that the hollow is moved alternately adjacent to the solids inlet and the solids outlet. The solid particles pass into the hollow as the hollow is adjacent to the solids inlet, and pass out of the hollow as the hollow is adjacent to the solids outlet.

The solid particles may comprise comminuted ores, powders, grains, granulated sugars, powdered grains, salts, sand, cryogenic solids, metal particles, plastics, or combinations thereof.

The piston may rotate as the piston traverses the piston chamber, such that the hollow is inverted.

The piston may compress a gas from the solids receptacle in an end of the piston chamber as the hollow approaches the solids outlet. The gas may provide a force pushing the piston away from the end of the piston chamber as the hollow is adjacent to the solids outlet. The piston chamber may comprise a path for the gas to pass from the end of the piston chamber into the hollow as the hollow is adjacent to the solids outlet, such that the gas blows through the hollow and assists the solid particles to leave the hollow into the solids receptacle.

The source may comprise a hopper, tank, vessel, pipe, chute, or combinations thereof. The solids receptacle may comprise a stockpile, tank, vessel, pipe, chute, or combinations thereof.

A plurality of pistons in a plurality of piston chambers may be provided, radially situated around a central cam, rotation of the cam causing the plurality of pistons to traverse back and forth across the plurality of piston chambers.

The piston may be hydraulically actuated, pneumatically actuated, or mechanically actuated. The hollow may comprise a removable sleeve that allows for a variable volume.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A-E show cross-sectional side views and isometric views of a piston for transferring solid particles between zones of different pressures.

FIG. 2 shows a cross-sectional side view of a piston for transferring solid particles between zones of different pressures.

FIGS. 3A-D show cross-sectional side views and an isometric view of a piston for transferring solid particles between zones of different pressures.

FIGS. 4A-F show cutaway views and isometric views of a disc containing pistons for transferring solid particles between zones of different pressures.

FIG. 5 shows a method for transferring solid particles between zones of different pressures.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

The ambient conditions referred to herein may comprise differing pressures, temperatures, fluids, lumosity, or combinations thereof. Pressures are used throughout, but may be replaced by any of the other conditions listed.

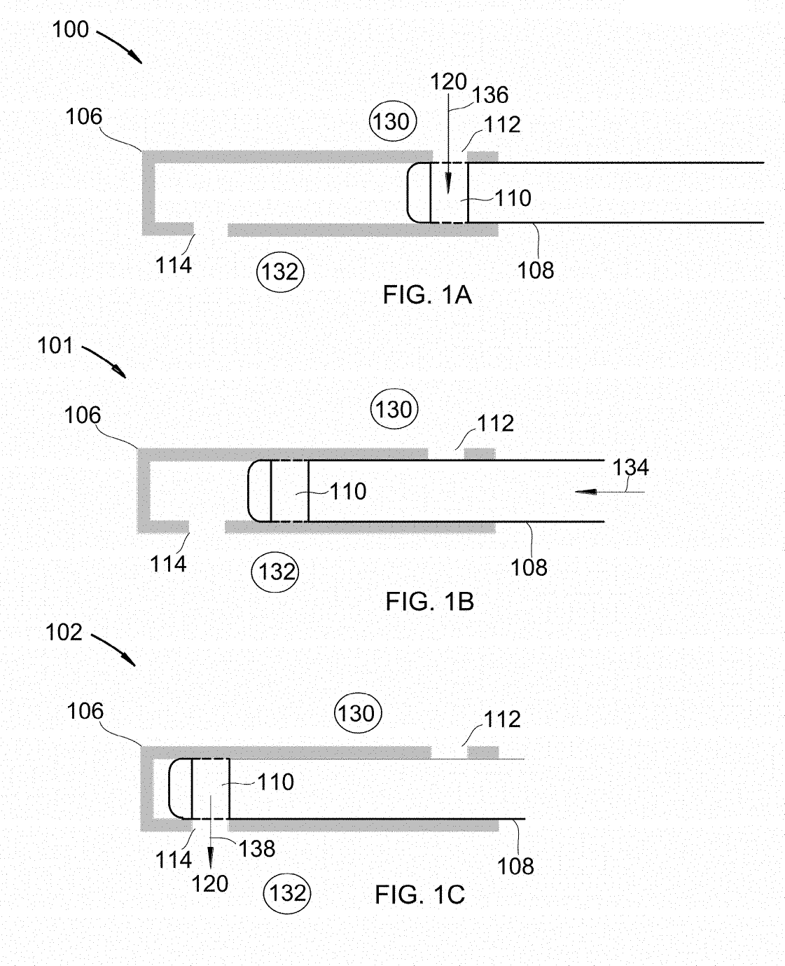

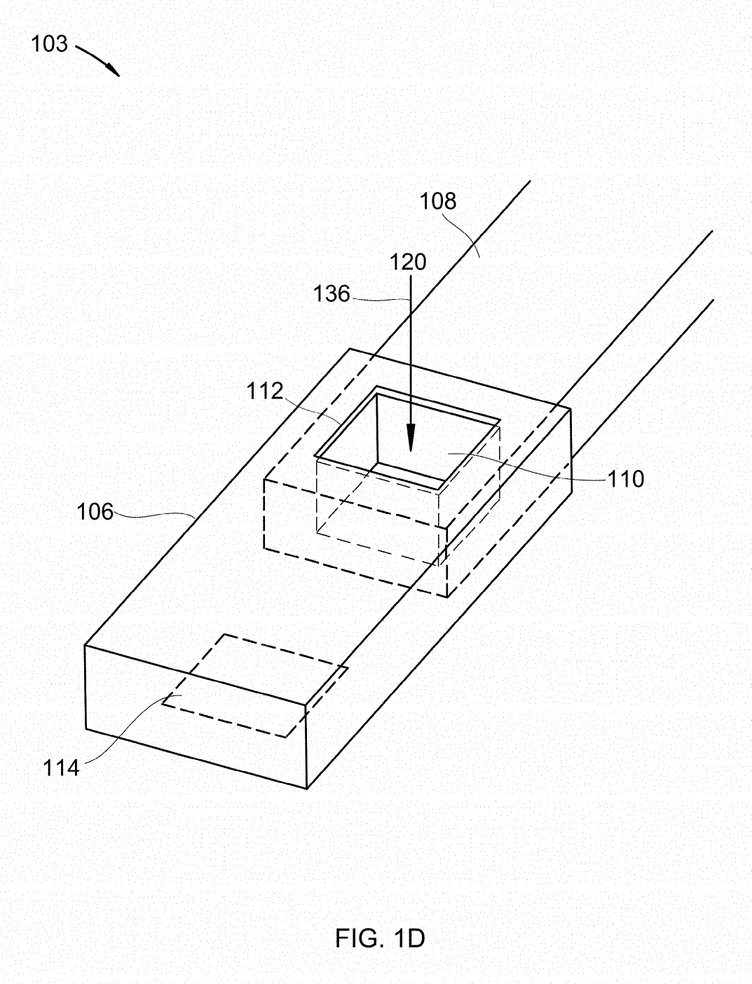

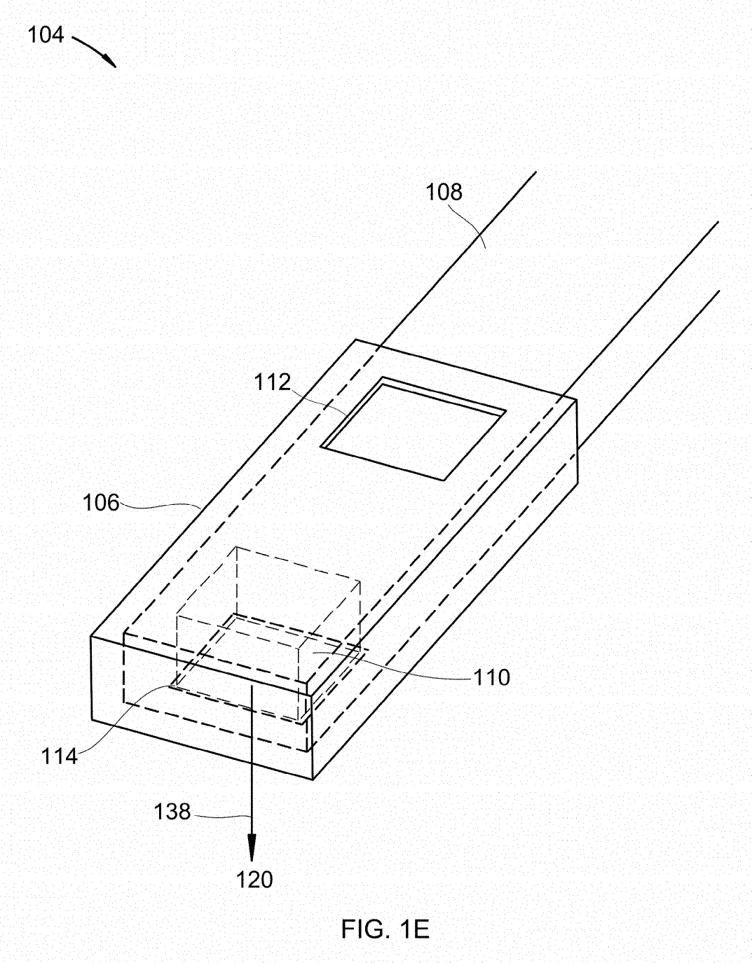

Referring to FIGS. 1A-E, cross-sectional side views and isometric views of a piston for transferring solid particles between zones of different pressures are shown at 100 through 104, as per one embodiment of the present invention. Piston chamber 106 comprises solids inlet 112, solids outlet 114, and piston 108. Piston 108 comprises hollow 110. Piston chamber 106 separates first pressure zone 130 and second pressure zone 132. First pressure zone 130 is a solids source. Second pressure zone 132 is a solids receptacle. Piston 108 traverses back and forth across piston chamber 106 such that hollow 110 is moved alternately adjacent to solids inlet 112 and solids outlet 114. As hollow 110 is adjacent to solids inlet 112, solid particles 120 pass 136 into hollow 110. Piston 108 then traverses 134 piston chamber 106, moving hollow 110 adjacent to solids outlet 114. Solid particles 120 then pass 138 out of solids outlet 114 into the solids receptacle. In this manner, solids are transferred between first pressure zone 130 and second pressure zone 132 without appreciable pressure losses or gains.

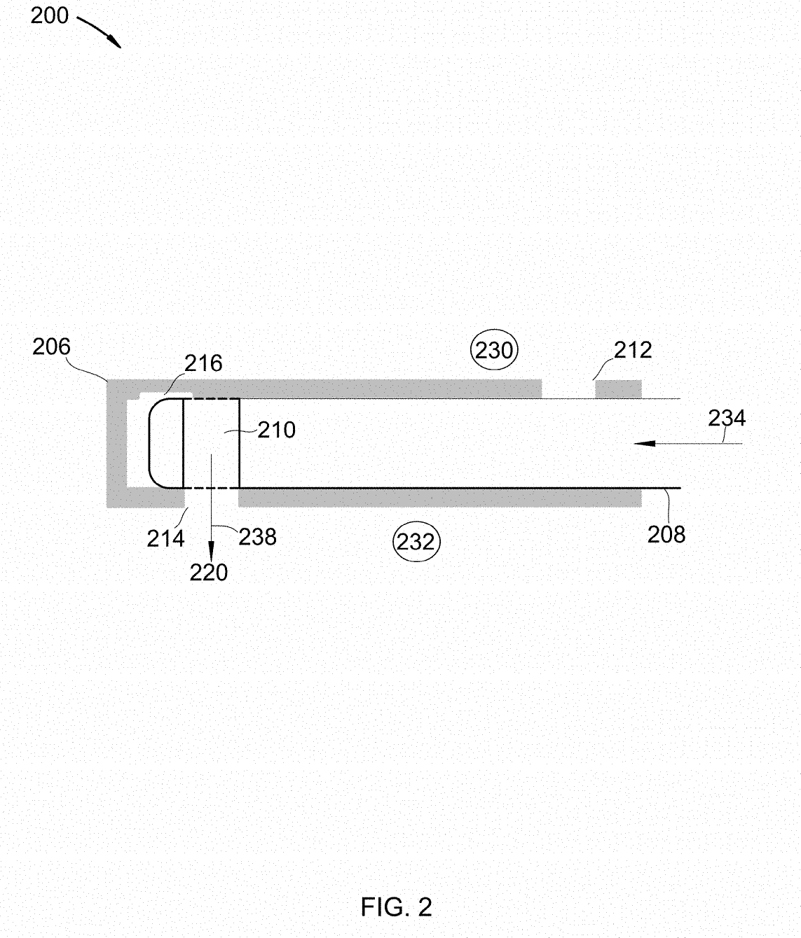

Referring to FIG. 2, a cross-sectional side view of a piston for transferring solid particles between zones of different pressures is shown at 200, as per one embodiment of the present invention. This figure is the same as FIG. 1B, except gas path 214 is added. Specifically, as piston 208 traverses 234 piston chamber 206, gas present in piston chamber 206 from second pressure zone 232 becomes trapped and compressed as the piston passes the edge of solids outlet 214. This air is forced through gas path 216, blowing solid particles 220 out of hollow 210.

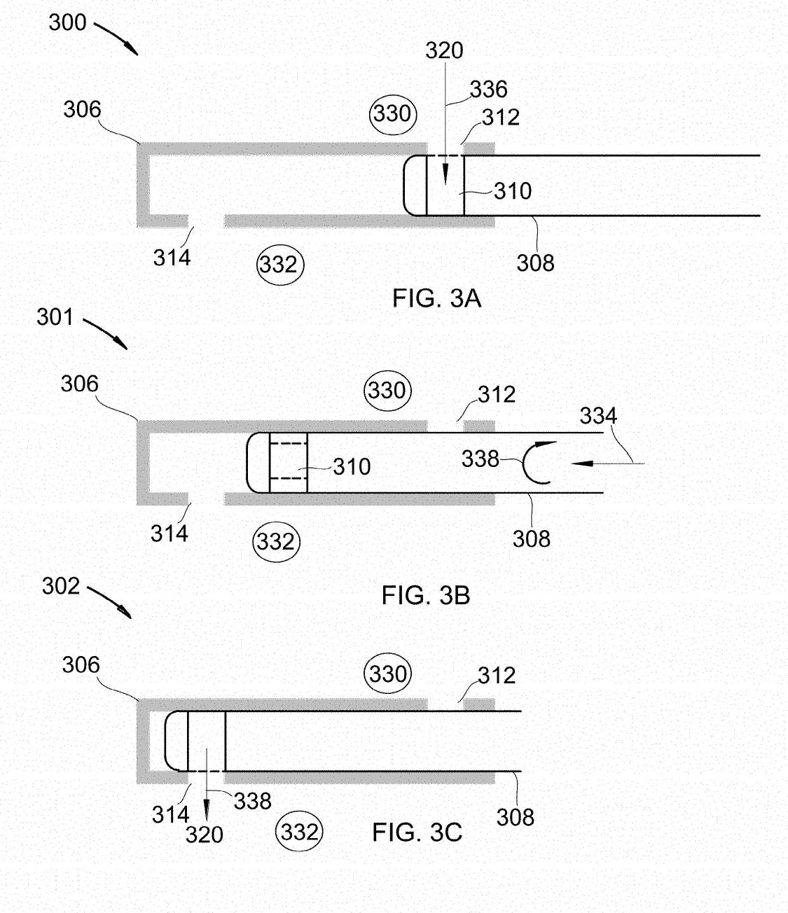

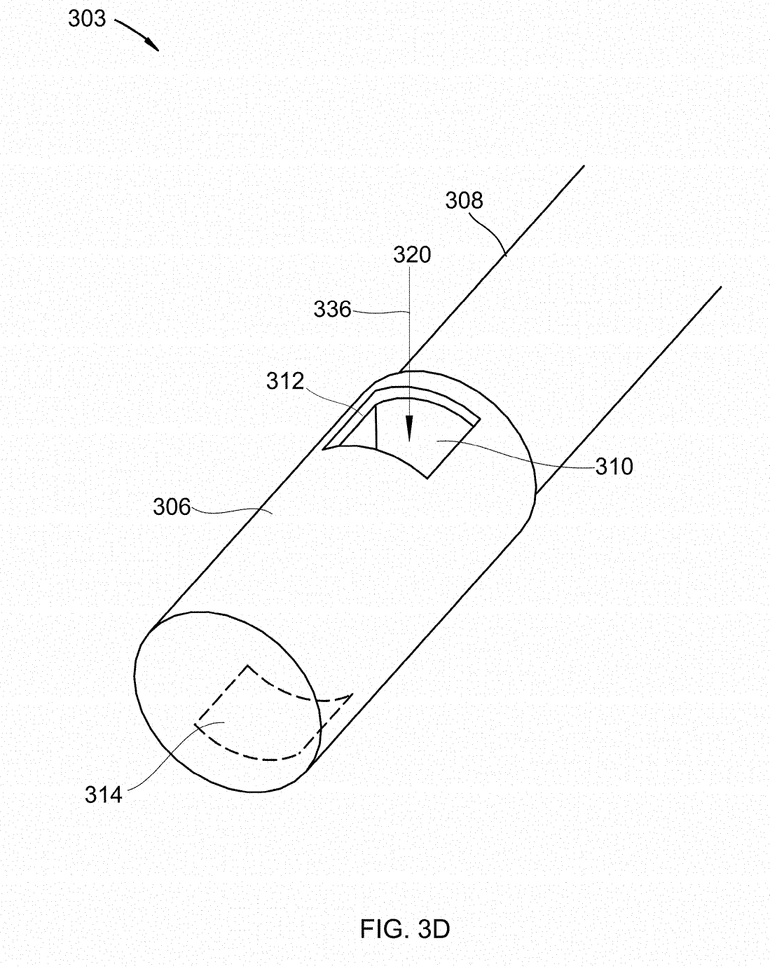

Referring to FIGS. 3A-D, cross-sectional side views and an isometric view of a piston for transferring solid particles between zones of different pressures are shown at 300 through 304, as per one embodiment of the present invention. Piston chamber 306 comprises solids inlet 312, solids outlet 314, and piston 308. Piston 308 comprises hollow 310. Piston chamber 306 separates first pressure zone 330 and second pressure zone 332. First pressure zone 330 is a solids source. Second pressure zone 332 is a solids receptacle. Piston 308 traverses back and forth, while rotating, across piston chamber 306 such that hollow 310 is moved alternately adjacent to solids inlet 312 and solids outlet 314. As hollow 310 is adjacent to solids inlet 312, solid particles 320 pass 336 into hollow 310. Piston 308 then traverses 334 piston chamber 306 while rotating 338, inverting and moving hollow 310 adjacent to solids outlet 314. Solid particles 320 then pass 338 out of solids outlet 314 into the solids receptacle. In this manner, solids are transferred between first pressure zone 330 and second pressure zone 332 without appreciable pressure losses or gains.

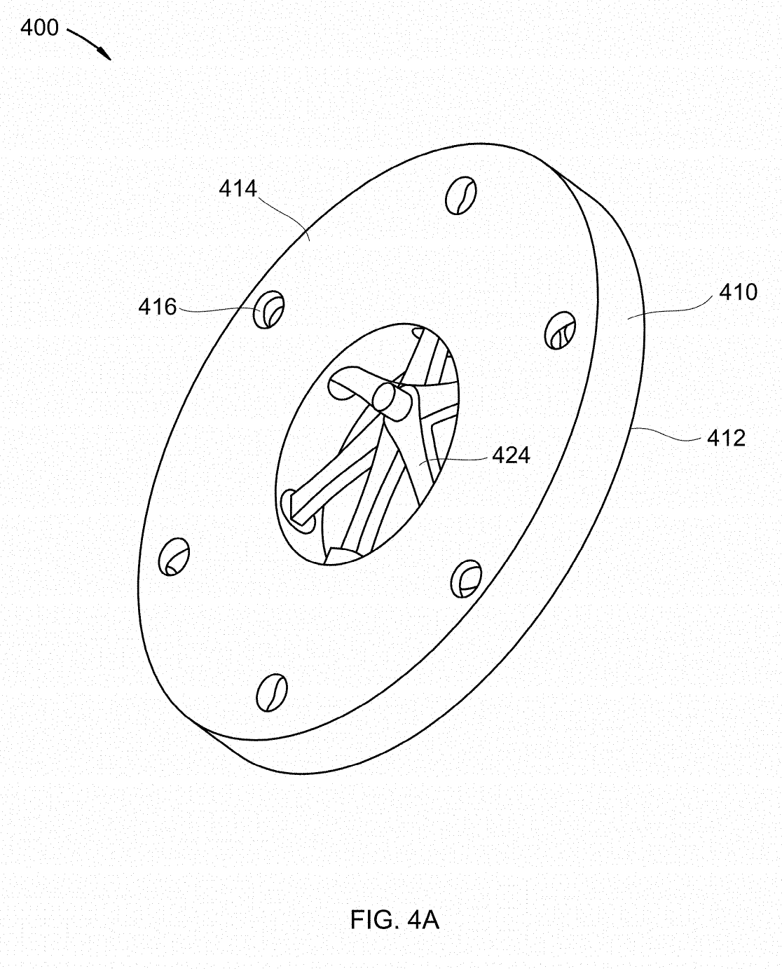

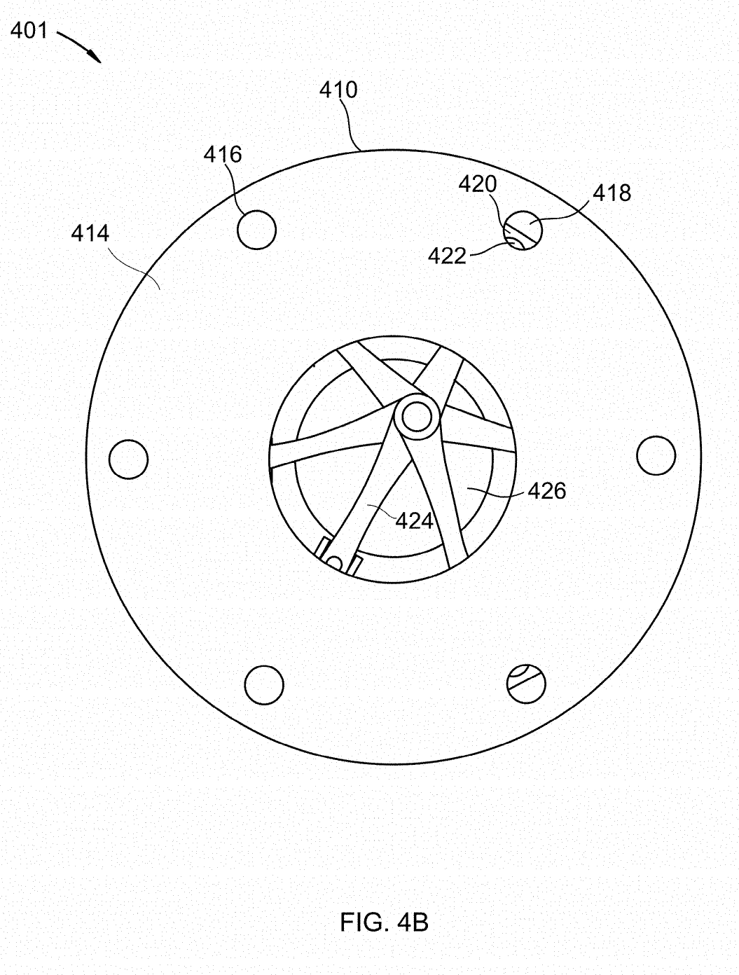

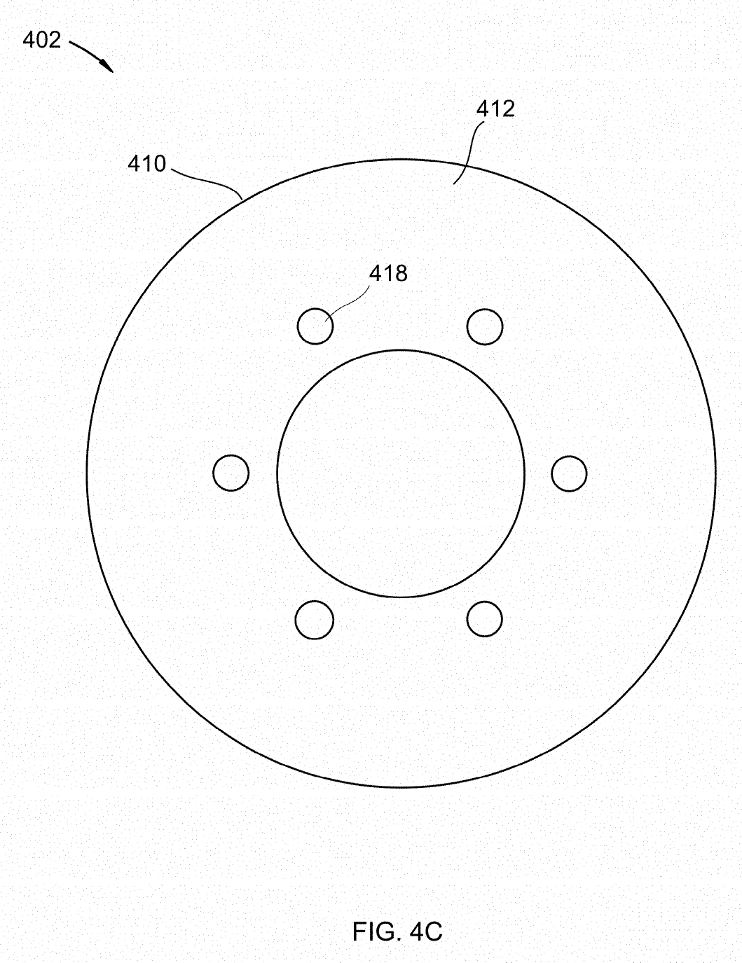

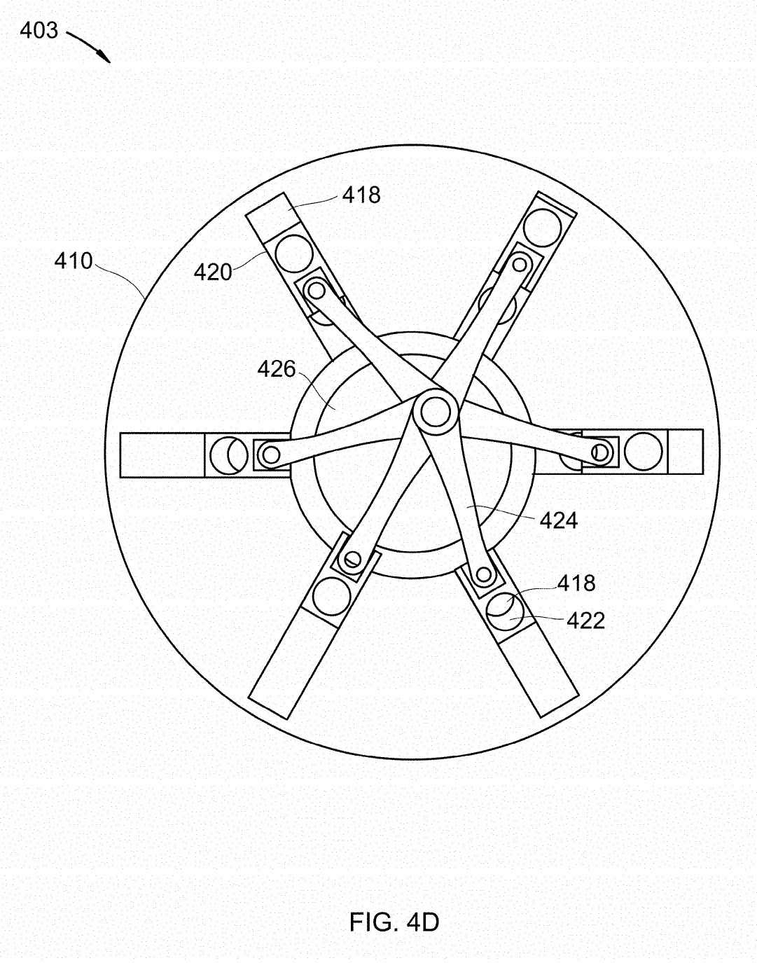

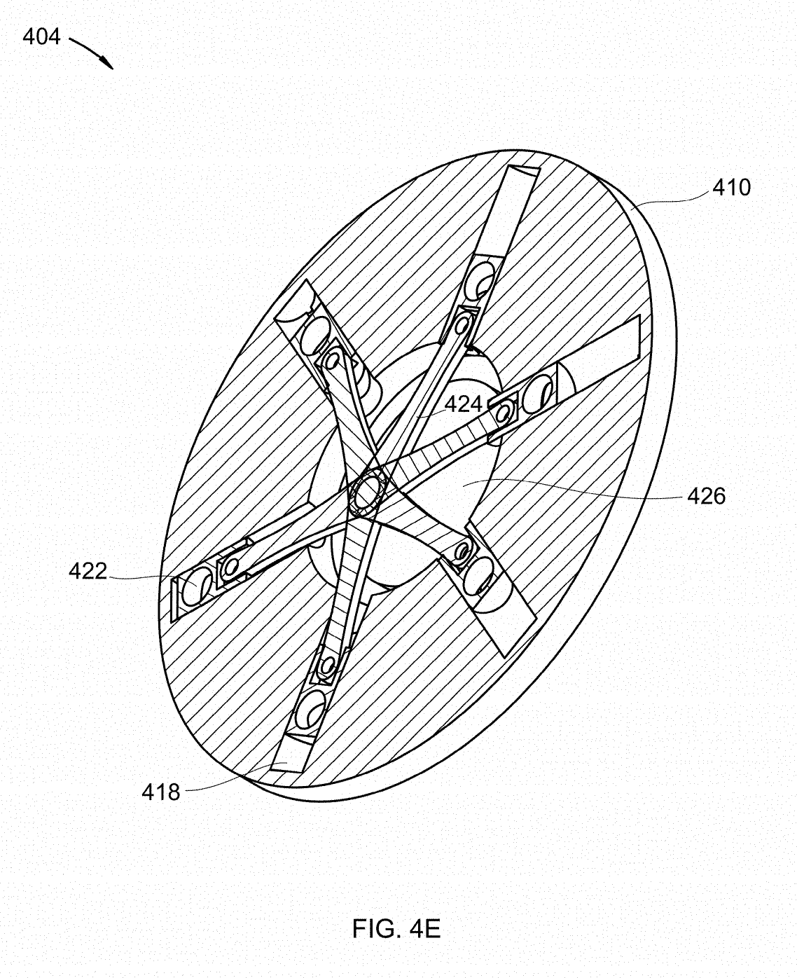

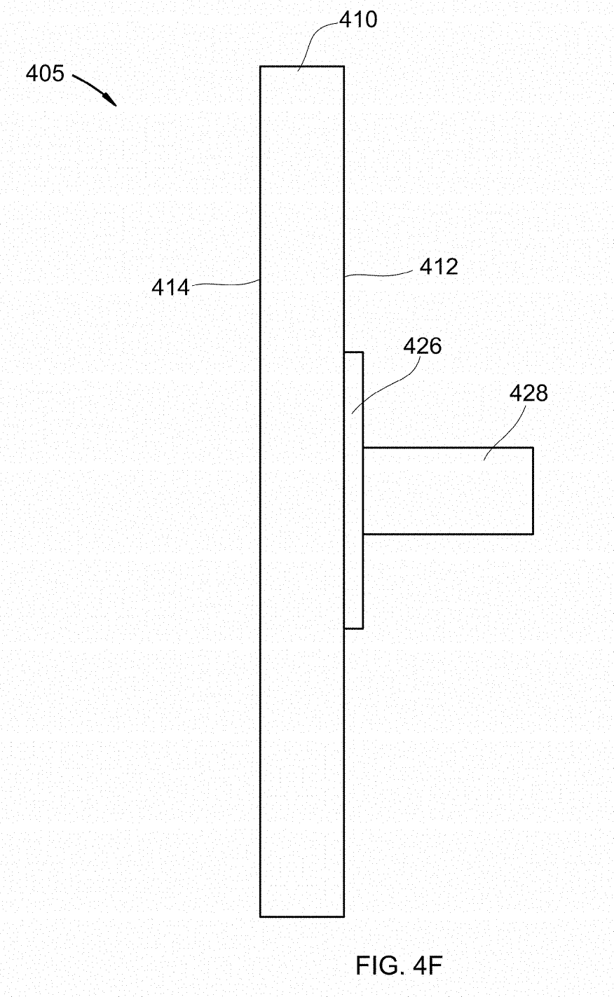

Referring to FIGS. 4A-F, cutaway views and isometric views of a disc containing pistons for transferring solid particles between zones of different pressures are shown at 400 through 405, as per one embodiment of the present invention. Disc 410 comprises face 412, face 414, outer holes 416, inner holes 418, pistons 420, connecting rods 424, crankshaft 426, and driveshaft 428. Faces 412 and 414 are shown without covers or pressure seals around the central portion of the disc for clarity. Pistons 420 comprises hollows 422. Disc 414 is stationary and forms a pressure seal between a first pressure zone on face 412 and a second pressure zone 414. Driveshaft 428 turns crankshaft 426, which causes connecting rods 424 to move pistons 420 in and out of piston chambers 418, causing hollows 422 to traverse alternately adjacent to outer holes 416 and inner holes 418. In some embodiments, outer holes 416 face upwards and are therefore the solids inlet. In some embodiments, inner holes 418 face upwards and are therefore the solids inlet. The opposite holes are the outlets. As hollows 422 are adjacent to the solids inlet, solid particles pass into hollows 422. Pistons 420 then traverse piston chambers 418, moving hollows 422 adjacent to the solids outlet. The solid particles then pass out of the solids outlet into the solids receptacle. In this manner, solids are transferred between the first pressure zone and the second pressure zone without appreciable pressure losses or gains.

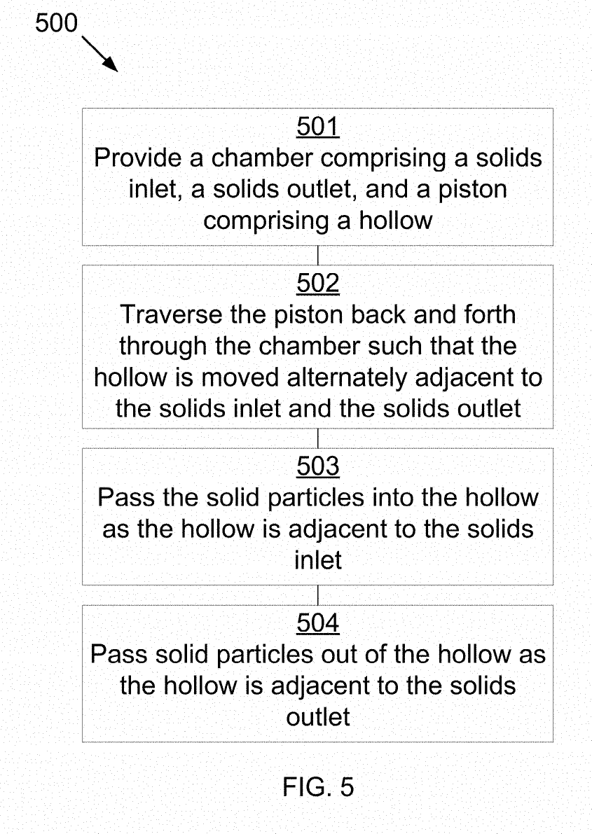

Referring to FIG. 5, a method for transferring solid particles between zones of different pressures is shown at 500, as per one embodiment of the present invention. A piston chamber is provided comprising a solids inlet, a solids outlet, and a piston comprising a hollow 501. The solids inlet is adjacent to a source of solid particles, the source being at a first pressure, and the solids outlet is adjacent to a solids receptacle, the solids receptacle being at a second pressure. The piston traverses back and forth through the piston chamber such that the hollow is moved alternately adjacent to the solids inlet and the solids outlet 502. The solid particles pass into the hollow as the hollow is adjacent to the solids inlet 503. The solid particles pass out of the hollow as the hollow is adjacent to the solids outlet 504.

In some embodiments, the solid particles comprise comminuted ores, powders, grains, granulated sugars, powdered grains, salts, sand, cryogenic solids, metal particles, plastics, or combinations thereof.

In some embodiments, the piston rotates as the piston traverses the piston chamber, such that the hollow is inverted.

In some embodiments, the piston compresses a gas from the solids receptacle in an end of the piston chamber as the hollow approaches the solids outlet. In one embodiment, the gas provides a force pushing the piston away from the end of the piston chamber as the hollow is adjacent to the solids outlet. In another embodiment, the piston chamber comprises a path for the gas to pass from the end of the piston chamber into the hollow as the hollow is adjacent to the solids outlet, such that the gas blows through the hollow and assists the solid particles to leave the hollow into the solids receptacle.

In some embodiments, the source comprises a hopper, tank, vessel, pipe, chute, or combinations thereof. In some embodiments, the solids receptacle comprises a stockpile, tank, vessel, pipe, chute, or combinations thereof.

In some embodiments, a plurality of pistons in a plurality of piston chambers are radially situated around a central cam or shaft, rotation of the cam or shaft causing the plurality of pistons to traverse back and forth across the plurality of piston chambers.

In some embodiments, the piston is hydraulically actuated, pneumatically actuated, or mechanically actuated. In some embodiments, the hollow comprises a removable sleeve that allows for a variable volume.

In some embodiments, the source is caused to vibrate to cause the solid particles to fall into the hollow of the piston.

1. A device for transferring solid particles between zones comprising the same or varying ambient conditions comprising:
a piston chamber comprising a solids inlet, a solids outlet, and a piston;
the solids inlet being adjacent to a source of solid particles, the source being at a first ambient condition, and the solids outlet being adjacent to a solids receptacle, the solids receptacle being at a second ambient condition:
the piston comprising a hollow, wherein:
the piston traverses back and forth across the piston chamber such that the hollow is moved alternately adjacent to the solids inlet and the solids outlet;
the solid particles pass into the hollow as the hollow is adjacent to the solids inlet, and pass out of the hollow as the hollow is adjacent to the solids outlet.

2. The device of claim 1, wherein the solid particles comprise comminuted ores, powders, grains, granulated sugars, powdered grains, salts, sand, cryogenic solids, metal particles, plastics, or combinations thereof.

3. The device of claim 1, wherein the piston rotates as the piston traverses the piston chamber, such that the hollow is inverted.

4. The device of claim 1, wherein the piston compresses a gas from the solids receptacle in an end of the piston chamber as the hollow approaches the solids outlet.

5. The device of claim 4, wherein the gas provides a force pushing the piston away from the end of the piston chamber as the hollow is adjacent to the solids outlet.

6. The device of claim 4, wherein the piston chamber comprises a path for the gas to pass from the end of the piston chamber into the hollow as the hollow is adjacent to the solids outlet, such that the gas blows through the hollow and assists the solid particles to leave the hollow into the solids receptacle.

7. The device of claim 1, wherein the source comprises a hopper, tank, vessel, pipe, chute, or combinations thereof.

8. The device of claim 1, wherein the solids receptacle comprises a stockpile, tank, vessel, pipe, chute, or combinations thereof.

9. The device of claim 1, wherein a plurality of pistons in a plurality of piston chambers are radially situated around a central cam, rotation of the cam causing the plurality of pistons to traverse back and forth across the plurality of piston chambers.

10. The device of claim 1, wherein the hollow comprises a removable sleeve that allows for a variable volume.

11. A method for transferring solid particles between zones comprising the same or varying ambient conditions comprising:
providing a piston chamber comprising a solids inlet, a solids outlet, and a piston comprising a hollow, wherein the solids inlet is adjacent to a source of solid particles, the source being at a first ambient condition, and the solids outlet is adjacent to a solids receptacle, the solids receptacle being at a second ambient condition:
traversing the piston back and forth through the piston chamber such that the hollow is moved alternately adjacent to the solids inlet and the solids outlet;
passing the solid particles into the hollow as the hollow is adjacent to the solids inlet, and passing the solid particles out of the hollow as the hollow is adjacent to the solids outlet.

12. The method of claim 11, wherein the solid particles comprise comminuted ores, powders, grains, granulated sugars, powdered grains, salts, sand, cryogenic solids, metal particles, plastics, or combinations thereof.

13. The method of claim 11, further comprising rotating the piston as the piston traverses the piston chamber, such that the hollow is inverted.

14. The method of claim 11, further comprising the piston compressing a gas from the solids receptacle in an end of the piston chamber as the hollow approaches the solids outlet.

15. The method of claim 14, further comprising the gas providing a force pushing the piston away from the end of the piston chamber as the hollow is adjacent to the solids outlet.

16. The method of claim 14, wherein the piston chamber comprises a path for the gas to pass from the end of the piston chamber into the hollow as the hollow is adjacent to the solids outlet, such that the gas blows through the hollow and assists the solid particles to leave the hollow into the solids receptacle.

17. The method of claim 11, wherein the source comprises a hopper, tank, vessel, pipe, chute, or combinations thereof.

18. The method of claim 11, wherein the solids receptacle comprises a stockpile, tank, vessel, pipe, chute, or combinations thereof.

19. The method of claim 11, providing a plurality of pistons in a plurality of piston chambers radially situated around a central cam, rotation of the cam causing the plurality of pistons to traverse back and forth across the plurality of piston chambers.

20. The method of claim 11, wherein the hollow comprises a removable sleeve that allows for a variable volume.
